(19) United States
(12) Patent Application Publication
(10) Pub. No.: US 2015/0125142 A1
(43) Pub. Date: May 7, 2015

(54) DATA COMMUNICATION APPARATUS

(71) Applicant: MIC AG, Munich (DE)

(72) Inventor: Claus-Georg Mueller, Munich (DE)

(21) Appl. No.: 14/400,202

(22) PCT Filed: May 8, 2013
(86) PCT No.: PCT/EP2013/001375

§ 371 Date: Nov. 10, 2014

(30) Foreign Application Priority Data
May 10, 2012 (DE) 20 2012 004 728.0

(51) Int. Cl. H04B 10/25; H04B 10/077

(52) U.S. Cl. CPC H04B 10/25; H04B 10/077
USPC 398/16; 398/141

(57) ABSTRACT

The present invention relates to a data communication apparatus having at least two server communication terminals, which are connected by at least one optical cable and which each have at least one transmitter and one receiver, wherein the transmitter of a first communication terminal is connected to the receiver of a second communication terminal by a first fiber optic passage and the receiver of the first communication terminal is connected to the transmitter of the second communication terminal by a second fiber optic passage, wherein a circuit tester having an evaluation unit for evaluating test and/or error signals transmitted by the optical cable is provided for detecting damage to and/or disturbances of the optical cable. In accordance with the invention, the circuit tester is integrated into the first and/or second server, the two fiber optic passages being further connected by at least one signal diversion module.

The present invention relates to a data communication apparatus, in particular in the form of a network, having at least two communication terminals, preferably in the form of servers, which are connected to one another by at least one optical cable and which each have at least one transmitter and one receiver, wherein the transmitter of a first one of the two communication terminals is connected to the receiver of the second one of the two communication terminals by a first fiber optic passage and the receiver of the first communication terminal is connected to the transmitter of the second communication terminal by a second fiber optic passage, wherein a circuit tester having an evaluation unit for evaluating test signals and/or error signals transmitted by the optical cable is provided for detecting damage to and/or disturbances of the optical cable.

Data communication networks having a plurality of servers communicating to one another have recently frequently been cabled with optical cables, for example in the form of fiber optic cables, to allow high data transfer speeds and data transfer quantities. The connection of the communication terminals or servers can in this respect take place in ring form, star form, nodal point form or in mixed forms thereof or also in another manner, wherein typically at least two fiber optic passages are provided between two mutually connected servers to be able to transfer light signals in opposite directions in parallel in time. A first fiber optic passage connects the transmitter of the one server to the receiver of the other server, while a second fiber optic passage conversely connects the transmitter of the other server to the receiver of the aforesaid one server. The fiber optic passages can in this respect be integrated into a common fiber optic cable or a common optical cable.

The transmitters or receivers of the communication terminals or servers respectively are in this respect optical modules such as laser signal generators and laser signal receivers for generating or detecting corresponding light signals which typically operate in predefined wavelength range or in a predefined light color, for example around 1550 nm.

To be able to localize disturbances in the data transmission as a result of damage to the cables, a test device is typically coupled to a cable harness via a feed point, wherein the test device feeds in signals at a different frequency or in a different light color so that cable damage can be localized using the superimposed test signal during the communication. The connected additional equipment receives the light signals which are reflected at the cable damage and which can be evaluated in a manner known per se.

For example, document U.S. Pat. No. 7,068,940 B1 shows a monitoring system for monitoring light propagation in an optical transmission system, wherein test light signals of adjustable wavelength can be fed into the optical cable by a tunable signal generator. The fed-in test signals are branched out of the optical cable by means of a circulator connectable to the optical cable and are conducted to a detector which is connected to the bypass output of the circulator and which evaluates the test signals or the derived signals resulting therefrom.

Depending on the complexity of the network and of the cable structure, such a cable damage diagnosis is more or less complicated and complex in implementation since the test signal generator and the named detector optionally have to be connected to a plurality of cables until the damaged cable can be detected.

Starting from this, it is the underlying object of the invention to provide an improved data communication apparatus of the named kind which avoids disadvantages of the prior art and further develops the latter in an advantageous manner. The cable damage diagnosis should in particular be simplified so that cable damage can be localized faster with a smaller technical hardware effort.

The named object is achieved in accordance with the invention by a data communication apparatus in accordance with claim 1. Preferred embodiments of the invention are the subject of the dependent claims.

It is proposed to utilize the transmission and/or reception devices of the servers or communication terminals respectively for the diagnosis operation so that no separate test signal hardware is required and has to be connected. In accordance with the invention, the circuit tester is integrated into the first server and/or second server and is connected to its/their transmitter(s) and receiver(s), wherein the two fiber optic passages connecting the servers to one another are connected to one another by at least one signal diversion module. The signal diversion module provided between the fiber optic passages in this respect conducts light propagated in the wrong direction and reflected by a damaged cable point to the respective other fiber optic passage in order to be able to be received by the receiver of the respective server connected to said other fiber optic passage so that the evaluation device can evaluate this diverted signal received at the receiver of one of the two servers. The named signal diversion module in this respect diverts signals transferred in the first fiber optic passage in the direction from the receiver of the second server to the transmitter of the first server onto the second fiber optic passage to the receiver of the first server. Alternatively or additionally, the named signal diversion module in the second fiber optic passage can divert signals transferred in the direction from the receiver of the first server to the transmitter of the second server onto the first fiber optic passage to the receiver of the second server. The evaluation device of the circuit tester evaluates the signals diverted by the signal diversion module and received at one of the receivers of the servers to determine cable damage on the basis thereof.

The invention in this respect starts from the consideration that such signals propagating in the wrong direction, i.e. signals running from the receiver to the transmitter in a respective fiber optic passage, only occur with damaged fiber optic passages, in particular when signals running in the “correct” direction, i.e. signals propagating from the transmitter to the receiver in the connecting fiber optic passage, are reflected at a damaged cable point. To be able to detect the reflected signal occurring in the event of damage, a diversion module is connected in the corresponding passage which diverts the reflected returning signal and forwards it to the receiver of the server to which the signal runs back. Such a signal diversion module can be configured as a circulator which can have at least three outputs and which can work such that light signals fed in at the first output or connection are conducted through to the second connection without hindrance, whereas signals fed in at said second connection are not conducted back to the first connection, but are rather output at a third connection. The circulator can thus be connected to the first and second connections in the fiber optic passage which connects the transmitter of the one server to the receiver of the other server, whereas the third output or connection of the circulator is connected to the fiber optic passage for the opposite signal transmission or is connected directly to the receiver of the server whose transmitter is connected to the fiber optic passage in which the first two connections of the circulator are connected.

Instead of a circulator, in principle a coupler can also be used as the signal diversion module which conducts or transmits returning signals both to the transmitter and to the receiver of the server. In principle, a switch can also be used as the signal diversion module in principle which selectively conducts returning signals to the transmitter or to the receiver of the server in dependence on the switch state. The switchover can in this respect, for example, be controlled in dependence on the test signal such that the switch first transmits the test signal from the transmitter of the first server to the receiver of the second server in a first position and that then a switch to a second switch position is made to divert signals, which are thrown back by possible reflections and which would return in a per se opposite direction to the transmitter of the first server, to the receiver of the first server.

However, the problems of the switchover and of the switchover speed and also the problems of the application of reflection signals unwanted per se onto the transmitter can be avoided in equal measure using the aforesaid circulator.

The connection of separate test signal generators and test signal receivers and the connection of corresponding switches can be dispensed with by the utilization of the transmitters and receivers already present at the servers and already connected to the optical cable, whereby not only the technical hardware equipment is reduced which is required for the cable damage diagnosis, but also the labor effort for the diagnosis is reduced.

In a further development of the invention, the named circuit tester and/or its evaluation device, with which the signals reflected by cable damage can be evaluated, can be configured in the form of a software module which can be loaded onto one server or advantageously onto both servers and which accesses the transmission and reception devices of the respective server. If the communication network comprises more than two servers, the named software module can also be loaded onto more than two communication terminals or servers, in particular also onto each server terminal, to be able to flexibly test the most varied connection paths between the different servers.

The named circuit tester can in this respect comprise transmission control means by means of which the transmitter of the respective server can be controlled to generated a test signal of a defined frequency and/or of a defined signal shape or signal sequence in a test operation mode and to feed it into the optical cable to be tested.

In this respect, work is carried out in the test operating mode with the same wavelengths or light colors as in the communication mode so that the laser of the transmitter can continue to be used in unchanged form and the receiver can also work in the intended reception spectrum. It would, however, generally also be possible to vary the signal frequency or the signal wavelength in test operation mode with respect to the communication mode.

In a further development of the invention, the sensitivity of the receiver can be increased in the test operation mode to be able to better receive the usually less intense reflected interference signals. The named circuit tester can comprise for this purpose reception control means for controlling the receiver of the first or second server or of a further server to adjust the reception sensitivity of the respective receiver in a predefined sensitivity range. In a further development of the invention, in this respect a step-wise adjustment, optionally also a stepless adjustment, of the sensitivity range can take place, for example such that the sensitivity of the receiver is increased gradually until returned signals are detected. On the one hand, an overexcitement or overmodulation of the receiver or even damage to the receiver can be avoided; on the other hand, fairly small cable damage with correspondingly smaller signal reflections is also reliably detected.

The above-mentioned signal diversion module for diverting the reflected signals, thus the signals running in the wrong direction, can generally be provided at a different point between two connected servers, with advantageously the signal diversion module being able to be provided directly at the end of the optical cable or directly at the transmission and reception connections of the server unit or of the optical cable connections connected thereto. It is hereby ensured that the total cable length is monitored and also damage in direct proximity to the connection terminals can be detected.

The signal diversion module can in this respect actually be connected to the optical cable or to its fiber optic passages. Alternatively, the signal diversion module can, however, also be provided between the light cable and the connections of the transmission device or reception device of the server.

In an advantageous further development, in this respect two such signal diversion modules can be provided between two mutually connected servers and, in an opposite arrangement, conversely divert the signals reflected by damage points in the different fiber optic passages in each case. In the first fiber optic passage, which connects the transmitter of the first server to the receiver of the second server, a first signal diversion module can divert returning signals which run in the direction from the receiver of the second server to the transmitter of the first server onto the second fiber optic passage or onto the receiver of the first server. A second signal diversion module can, in contrast, divert the signals which are directed back in the second fiber optic passage, which connects the transmitter of the second server to the receiver of the first server, from the receiver of the first server to the transmitter of the second server onto the first fiber optic passage or onto the receiver of the second server. Reflections arising in different directions can hereby be detected and cable damage points can be precisely determined. In this respect, evaluation units are advantageously integrated in both servers to be able to evaluate the signals received at the respective receiver and diverted by the signal diversion modules. Provision can, however, alternatively also be made to forward the signals which indicate damage points and have been picked up at the receivers of the servers and which have in particular been generated or detected in the test operation mode from the respective receiver onto a central evaluation unit which can be integrated in one of the two servers.

The invention will be explained in more detail in the following with reference to a preferred embodiment and to associated drawings. There are shown in the drawings:

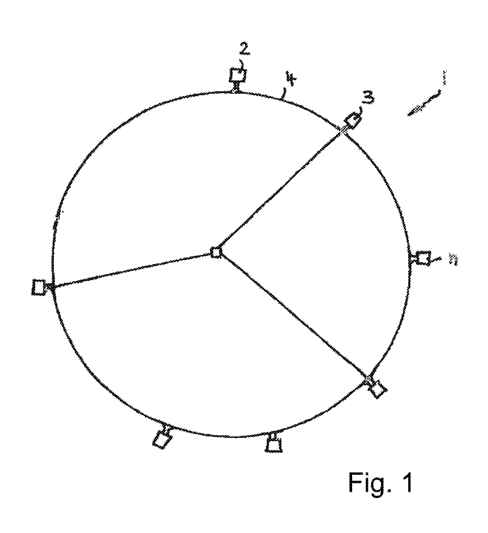

FIG. 1: a schematic representation of a data communication apparatus having a plurality of servers connected to one another by fiber optic cables; and

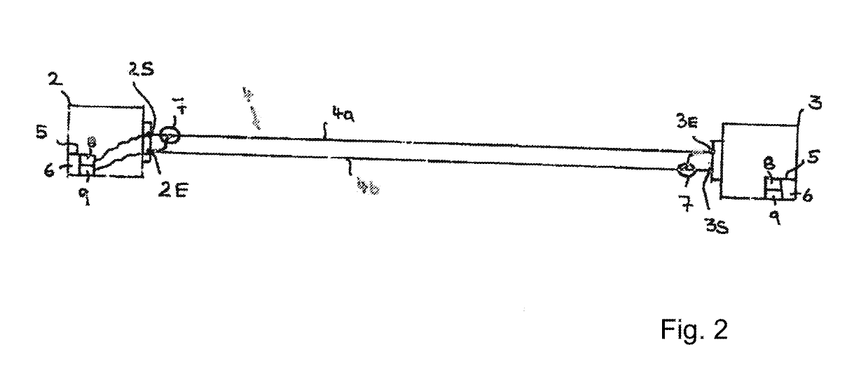

FIG. 2: a sectional, schematic representation of two mutually connected servers, wherein two signal diversion modules in the form of two circulators for diverting light signals reflected by damaged points are provided in the optical cable connecting the two servers to one another and evaluation units are integrated in the servers for evaluating the diverted signals.

FIG. 1 shows a data communication apparatus 1 having a plurality of communication terminals in the form of servers 2, 3, n which are connected to one another in the form of a network by optical cables 4 in the form of fiber optic cables. As FIG. 1 shows, the network cabling can here be configured in different manners, with some or all servers being able to be connected to one another in serial or ring form, whereas some other or also all servers can be connected to one another in a start-shaped configuration or in another configuration.

As FIG. 2 shows, the optical cable 4 between two servers 2 and 3 in this respect comprises two fiber optic passages 4A and 4B which each connect the transmitter of the one server to the receiver of the other server. Each server 2 and 3 in this respect has at least one transmitter 2S, 3S and one receiver 2E and 3E, via which light signals can be generated or received. The transmitters 2S or 3S respectively can in this respect comprise in a manner known per se laser devices for generating corresponding light signals, whereas the receivers 2D and 3E respectively can comprise reception sensor systems suitable for the light signals to be able to convert the light signals into electrical signals.

In communication operation, in this respect, signals are transmitted via the fiber optic passage 4A from the transmitter 2S of the first server 2 to the receiver 3S of the second server 3, whereas signals are transmitted via the fiber optic passage 4B from the transmitter 3S of the second server to the receiver 2E of the first server 2. The named fiber optic passages 4A and 4B can be separate cables, but can alternatively also be integrated in a common fiber optic cable.

To be able to determine cable damage or also disturbances, for example as a result of incorrectly mounted connection points or the like, test signals can be sent in a test operation mode via the transmitters 2S and 3S through the line 4 which typically generate reflections of the light signal on cable damage or on the named disturbances, the reflections then running back in the form of error signals opposite to the transfer direction per se provided in the respective fiber optic passage.

To be able to detect error signals running back in this manner, two signal diversion modules are installed in the named fiber optic passages 4A and 4B in the form of circulators 7 which divert the signals running back onto the receiver of the respective server 2 or 3. The named circulators 7 in this respect transmit light signals sent by the transmitter of a server 2 without hindrance through the respective fiber optic passage 4A and 4B, but prevent returned error signals from taking the same path back to the transmitter. The respective circulator 7 can in this respect have three connections 7A, 7B and 7C of which the first two connections 7A and 7B are connected to the fiber optic passage 4A (or, in the case of the second circulator, to the second fiber optic passage 4B), whereas the third connection 7C is connected to the other fiber optic passage 4B or to the receiver 2E of the server 2 (or, in the case of the second circulator, to the first fiber optic passage 4A or to the receiver 3E of the third server 3). The circulator is in this respect configured such that a light signal fed in at the first connection 7A is output without hindrance at the second connection 7B—and is thus transmitted without hindrance in the direction from the transmitter to the receiver through the respective fiber optic passage. If conversely a light signal is fed into the named second connection 7B, it is not conducted to the first connection 7A, but rather to the third connection 7C so that correspondingly returned error signals are diverted and can be detected at the receiver of the respective server.

Instead of the named circulators 7, in principle couplers can also be used as the signal diversion modules which conduct or transmit the signals running back both to the transmitter 2S or 3S and to the receiver 2E or 3E of the respective server 2 or 3. Equally, instead of the circulators 7, switches can also be used as signal diversion modules which selectively conduct signals running back to the transmitter 2S or 3S or to the receiver 2E or 3E of the respective server 2 or 3 in dependence on the switching state. The arrangement shown in the Figure would in this respect generally remain the same.

To be able to control the transmitter 2S or 3S of the respective sensor 2 or 3 and its receiver 2E or 3E in test mode operation, a circuit tester 5 is integrated in the respective server 2 or 3 which can be configured in the form of a software module which is loaded onto the respective server. The named circuit tester 5 in this respect advantageously comprises the initially already described transmission control means 8 and reception control means 9 by means of which the transmitters and receivers can be controlled which are associated with the respective server 2 or 3. The respective transmitter 2S or 3S can in particular output one or more light signals of defined frequency or wavelength in test mode operation, with work here advantageously being carried out at the same wavelength as in communication operation. The intensity of the receiver 2E or 3E can be set, in particular increased, to be able better to recognize the reflected error signals in test operation.

The error signals received in the test operation mode by the respective receiver 2E or 3E are evaluated by an evaluation device 6 which can advantageously be loaded onto the server in the form of a software module in order generally to be able to determine the presence of cable damage or cable disturbances. In addition, in this respect a localization of the error point can also be carried out by the evaluation of the error signals, for example by determining signal times of flight, for example such that the time interval between the sending of a test signal from the transmitter up to the reception of the diverted error signal at the receiver is determined. Alternatively or additionally, a localization of the damage point can also be carried out from other signal parameters such as signal strength or wavelength shift.

1. A data communication apparatus having at least two communication terminals in the form of servers, which are connected to one another by at least one optical cable and which each have at least one transmitter and one receiver, wherein the transmitter of a first one of the two communication terminals is connected to the receiver of the second one of the two communication terminals by a first fiber optic passage and the receiver of the first communication terminal is connected to the transmitter of the second communication terminal by a second fiber optic passage, wherein a circuit tester having an evaluation unit for evaluating one or more of test signals and error signals transmitted by the optical cable is provided for detecting one or more of damage to and disturbances of the optical cable, wherein the circuit tester is integrated into one or more of the first and second communication terminals and is connected to the transmitter and to the receiver of the one or more first and second communication terminals, wherein the first and second fiber optic passages are connected to one another by at least one signal diversion module by which, in the first fiber optic passage signals transmitted in the direction from the receiver of the second communication terminal to the transmitter of the first communication terminal can be one or more of diverted onto the second fiber optic passage to the receiver of the first communication terminal and diverted in the second fiber optic passage in the direction from the receiver of the first communication terminal to the transmitter of the second communication terminal onto the first fiber optic passage to the receiver of the second communication terminal, wherein the evaluation device evaluates diverted signals received at the receiver of the one or more first and second communication terminals.

2. The data communication apparatus in accordance with claim 1, wherein the circuit tester has transmission control means for controlling the transmitter of the one or more first and second communication terminals such that the one or more transmitters outputs a test signal of a defined frequency in a test operation mode.

3. The data communication apparatus in accordance with claim 2, wherein the transmitter of the one or more first and second communication terminals can be operated at the same wavelengths as in a communication mode in the test operation mode.

4. The data communication apparatus in accordance with claim 1, wherein the circuit tester has reception control means for controlling the receiver of the one or more first and second communication terminals such that the sensitivity of the one or more receivers is increased in a test operation mode.

5. The data communication apparatus in accordance with claim 1, wherein the circuit tester comprises transmission control means by means of which the transmitter of the one or more first and second communication terminals can be controlled in a test operation mode such that a test signal comprising one or more of a defined frequency and a defined signal shape and a signal sequence is generated and is fed into the optical cable to be tested.

6. The data communication apparatus in accordance with claim 1, wherein one or more of the circuit tester and the evaluation device comprise(s) a software module which can be loaded onto one or more of the communication terminals.

7. The data communication apparatus in accordance with claim 1, wherein the at least one signal diversion module is configured as a circulator which comprises one or more of, in the first fiber optic passage, diverting signals transmitted in the direction from the receiver of the second communication terminal to the transmitter of the first communication terminal onto the second fiber optic passage to the receiver of the first communication terminal and, in the second optical fiber passage, diverting signals transmitted in the direction from the receiver of the first communication terminal to the transmitter of the second communication terminal onto the first optical fiber passage to the receiver of the second communication terminal.

8. The data communication apparatus in accordance with claim 1, wherein the at least one signal diversion module is configured as one of a coupler and switch which comprises one or more of, in the first fiber optic passage, diverting signals transmitted in the direction from the receiver of the second communication terminal to the transmitter of the first communication terminal at least also onto the second fiber optic passage to the receiver of the first communication terminal and, in the second optical fiber passage, diverting signals transmitted in the direction from the receiver of the first communication terminal to the transmitter of the second communication terminal at least also onto the first optical fiber passage to the receiver of the second communication terminal.

9. The data communication apparatus in accordance with claim 1, wherein the first and second fiber optic passages are connected to one another by two signal diversion modules, preferably in the form of two circulators, wherein a first one of the two signal diversion modules is configured and arranged such that, in the first fiber optic passage, signals transmitted in the direction from the transmitter of the first communication terminal to the receiver of the second communication terminal are transmitted without hindrance by the signal diversion module and, in the first fiber optic passage, signals transmitted in the direction from the receiver of the second communication terminal to the transmitter of the first communication terminal are conducted onto the second fiber optic passage to the receiver of the first communication terminal, and the second of the two signal diversion modules is configured and arranged such that, in the second fiber optic passage, signals transmitted in the direction from the transmitter of the second communication terminal to the receiver of the first communication terminal are transmitted without hindrance and, in the second fiber optic passage, signals transmitted in the direction from the receiver of the first communication terminal to the transmitter of the second communication terminal are conducted onto the first fiber optic passage to the receiver of the second communication terminal.

10. The data communication apparatus in accordance with claim 9, wherein the two signal diversion modules are each configured as circulators which comprise three connections and are configured such that light introduced at a first connection is output at the second connection and light fed in at the second connection is output at the third connection.
